(19) United States
(12) Patent Application Publication
(10) Pub. No.: US 2010/0212510 A1
(43) Pub. Date: Aug. 26, 2010

(54) FRYER HAVING AN ANGLED FRYPOT BOTTOM

(75) Inventors: HENRY PRESTON HUTSON, Bossier City, LA (US); LANE LANGFORD, Bethany, LA (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: FRYMASTER L.L.C.

(21) Appl. No.: 12/709,304

(22) Filed: Feb. 19, 2010

Related U.S. Application Data
(60) Provisional application No. 61/208,130, filed on Feb. 20, 2009.
(60) Provisional application No. 61/271,399, filed on Jul. 21, 2009.

(51) Int. Cl. A47J 37/12; G05B 15/00

(52) U.S. Cl. 99/331; 99/403; 700/275

(57) ABSTRACT

The present disclosure provides a fryer comprising a frypot having a burner, at least one air passage, and a blower in fluid communication with the air passage. The blower can circulate air through the air passage, to either enhance the heating of a cooking medium within the frypot, or to help regulate and control the temperature of the cooking medium and/or a temperature of the frypot. A controller can also be in communication with the blower and burner, to control the fryer to enter various cooking modes. The controller can control the fryer to enter a filtration mode to when the cooking medium needs to be filtered and/or cleaned.

### CROSS-REFERENCE TO RELATED APPLICATIONS

The present application claims the benefit of U.S. Provisional Application Nos. 61/208,130, filed on Feb. 20, 2009, and 61/271,399, filed on Jul. 21, 2009.

### BACKGROUND OF THE DISCLOSURE

1. Field of the Disclosure

The present disclosure relates to infra-red deep fat fryers. More particularly, the present disclosure relates to infra-red deep fat fryers having an angled frypot bottom, and which have a blower to enhance heating, and regulate the temperature of the frypot.

2. Description of the Related Art

When food products are cooked in oil in a deep fat fryer, debris such as food crumbs may fall off the food product and into the oil. If the debris remains for too long within the hot zone of the cooking oil, it can become charred. This can result in the cooking oil becoming fouled and acquiring the taste of the charred debris. The food products that are cooked can also be discolored by charred debris.

Some fryers attempt to address this problem with a feature called a cool zone. The cool zone can be located in a place within the frypot of the fryer, typically at a bottom portion thereof, that is at a cooler temperature than the rest of the cooking oil. Debris falls into the cool zone, and will not become charred. Cool zones are often too deep or voluminous, however, requiring a significant amount of oil, thus increasing operating costs of the fryer. They are also extremely difficult to clean.

In addition, current fryers control the temperature of the deep fryer by different methods, such as, by incorporating temperature sensors, timers and sensors having specific set points. However, with such methods there exists the possibility of temperature overshoot during cooking cycles such as recovery, start-up, idle and the cooking of the food products. One reason that such fryers have limited capability to control temperature, is due to the inability to cool the walls of the fryer pot.

By not being able to control the temperature during the cooking cycles, temperature overshoots can occur leading to excessive heating of the cooking oil. Further, the inability to control provide heat transfer away from the walls of the fryer pot causes scorching of remaining oil during filtration cycles. Both excessive heating of the oil and the scorching of remaining oil in the fryer pot reduce the effective cooking life of the oil and waste energy.

Accordingly, there is a need for a fryer that addresses these drawbacks.

### SUMMARY OF THE DISCLOSURE

In one embodiment, the present disclosure provides a frypot for cooking food products. The frypot comprises a bottom surface, a plurality of side walls, which form an interior volume for storing a cooking medium to cook the food products, and a burner connected to the bottom surface for heating the cooking medium through the bottom surface. The bottom surface comprises two angled portions, and the angled portions are angled so that there is no cold zone formed within the interior volume. The frypot may also have a bottom air passage between the burner and the bottom surface of the frypot, and at least one side air passage on an outer side of at least one of the side walls. A blower may be in fluid communication with bottom air passage and/or the side air passage. The bottom surface may comprise a flat middle portion connected to each of the angled portions, wherein the angled portions form a v-shape with the flat middle portion.

In another embodiment, the present disclosure provides a fryer for cooking food products, comprising a frypot, a blower, and at least one air passage within the frypot and in fluid communication with the blower, so that the blower passes air through the air passage.

In another embodiment, the present disclosure provides a method of operating a fryer for cooking food products, the fryer comprising a frypot and a cooking medium within the frypot. The method comprises the steps of controlling the fryer to enter a start up mode when the cooking medium is placed in the frypot, to raise a temperature of the cooking medium to a set point temperature, controlling the fryer to enter a cooking mode when the food products are placed in the fryer, and controlling the fryer to enter a filtration mode to filter and replace the cooking medium within the frypot. The method may also comprise the step of controlling the fryer to enter an idle mode, to keep the cooking medium at or near the set point temperature when no food products are being cooked by the fryer.

### BRIEF DESCRIPTION OF THE DRAWINGS

FIG. 1 shows a top view of the frypot of the fryer of the present disclosure;

FIG. 2 shows a front-cross sectional view of the frypot of FIG. 1, along line A-A; and

FIG. 3 shows a right side view of the frypot of FIG. 1, in addition to a blower assembly, air plenum, and drain valve assembly;

FIG. 4 shows a perspective view of a first embodiment of the fryer of the present disclosure; and

FIG. 5 shows a perspective view of a second embodiment of the fryer of the present disclosure.

### DETAILED DESCRIPTION OF THE DISCLOSURE

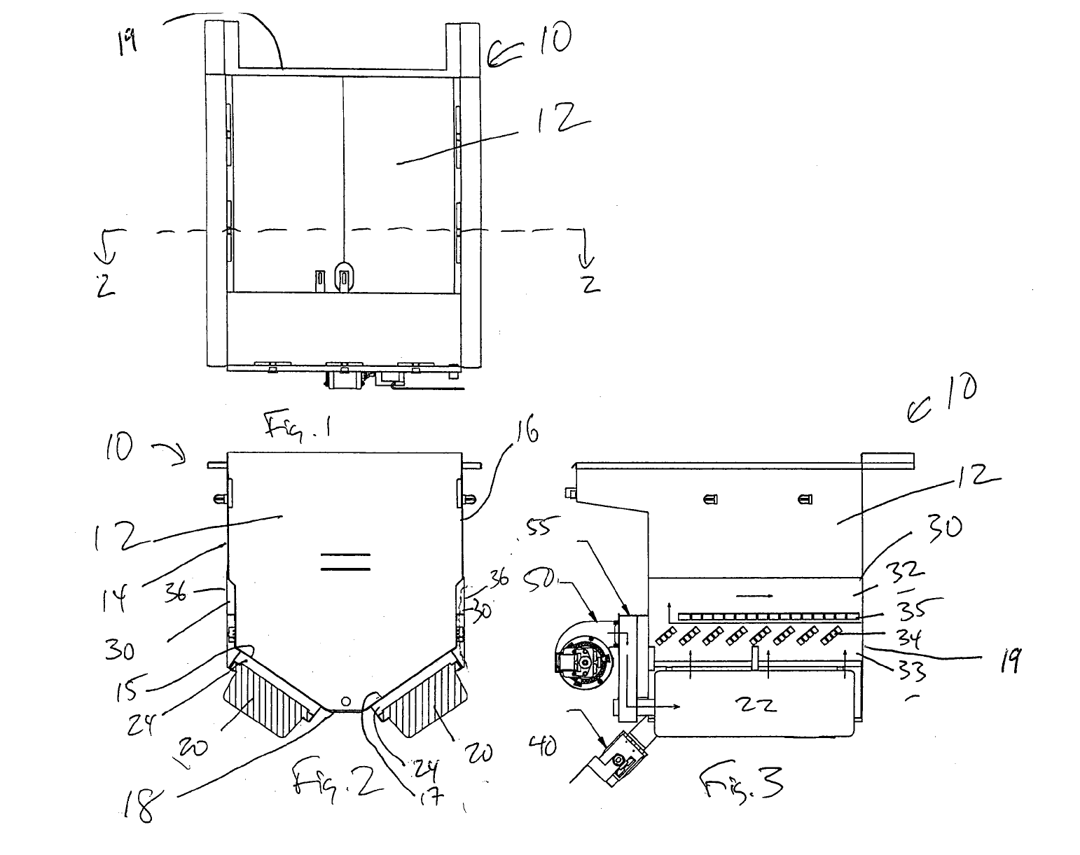

Referring to FIGS. 1-3, frypot 10 of the present disclosure is shown. During use, cooking oil is placed into interior volume 12, and heated according to the method discussed below. Frypot 10 has side walls 14 and 16, which have angled portions 15 and 17 at bottom portions thereof, respectively. Angled portions 15 and 17 thus form an angled or “v”-shape with bottom 18 of frypot 10. Frypot 10 can further have infrared burners 20 disposed on an outer surface of angled portions 15 and 17, which heat angled portions 15 and 17, and in turn the oil within interior volume 12. Frypot 10 also has rear wall 19.

Frypot 10 is highly advantageous over currently available frypots. Angled portions 15 and 17 are pitched at an appropriate angle, bottom 18 has an appropriate depth, and burners 20 are positioned with respect to bottom 18, so that a cold zone is not formed in frypot 10. Even though there is no cold zone in frypot 10, bottom 18 still provides a place for debris to fall during the cooking process, where it can be easily flushed during a cleaning process.

Furthermore, bottom 18 can be a substantially flat surface with respect to the horizontal, which assists in the prevention of the formation of a cold zone. In one embodiment, a vertical height from bottom 18 to a point at which burners 20 are connected to frypot 10 can be one inch, and in another embodiment it can be half an inch. Many currently available frypots have deep troughs or areas of the frypots disposed below burners. These troughs form cold zones, which are not used for cooking due to the large temperature gradient between the cold zone and the other areas of the frypot. In contrast, in frypot 10, all of interior 12 can be used for cooking, since there is no cold zone. The lack of a cold zone significantly reduces the amount of oil required for use in frypot 10.

Furthermore, frypot 10 is very easy to clean. When the customer determines that enough debris has collected in bottom 18 that it will begin to adversely affect frying of food products, the cooking oil can be removed from frypot 10 through drain valve 40. The cooking oil can then be filtered, cleaned, and put back into frypot 10, and the interior of frypot 10 can be washed and cleaned, all in a very short amount of time. This is due to the low oil volume, and v-shaped geometry of frypot 10. The filtration and cleaning process is disclosed in the co-pending United States Application entitled “POWER WASHDOWN FOR DEEP FRYER SYSTEM,” having Attorney Docket No. 315.8883USU, filed on Feb. 19, 2010, which is incorporated herein by reference.

In the shown embodiment, burners 20 and angled portions 15 and 17 are disposed at about a thirty-five degree angle, with respect to the horizontal. The present disclosure, however, contemplates other angles, such as from ten to eighty degrees, or from thirty to sixty degrees. The exact angle that will be desirable for a particular application will depend on the specific parameters of the fryer being used. Angled portions 15 and 17 can have the same angle, or can be at different angles. The present disclosure contemplates any angle for either of angled portions 15 and 17 that is selected so that it provides a v-shape with bottom 18. This allows debris to collect easily in bottom 18, yet still optimizes heat transfer to the cooking oil within frypot 10, and does not leave a cold zone in frypot 10.

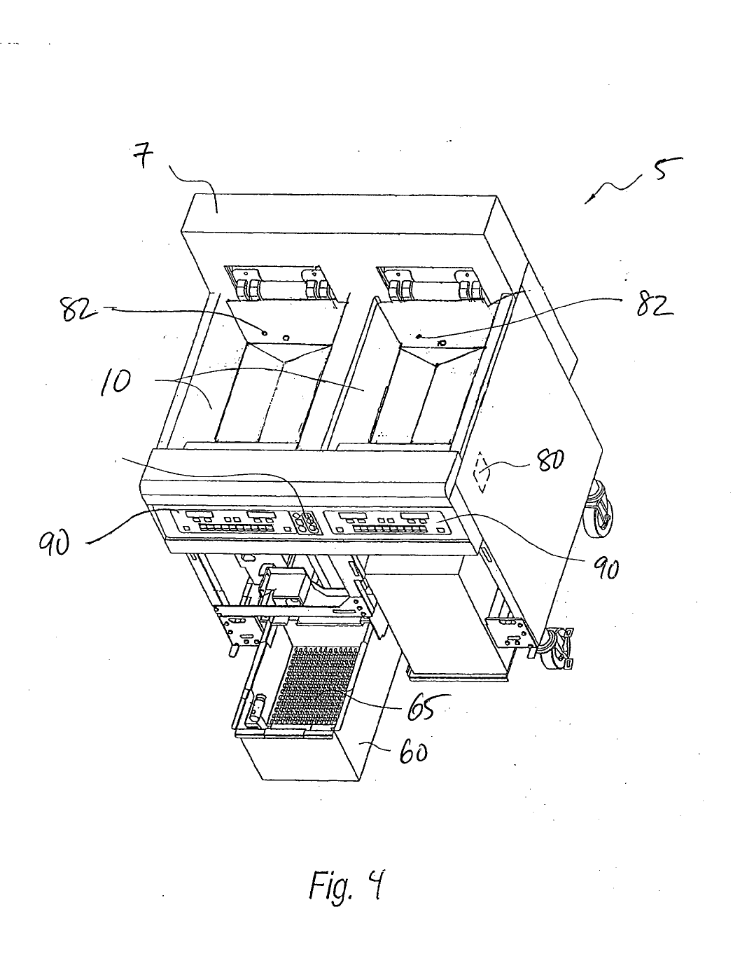

Referring specifically to FIGS. 2 and 3, frypot 10 can also have infrared heating zones 24, which are disposed between burners 20 and angled portions 15 and 17 of frypot 10. Frypot 10 can also have convective heating zones 30 along an outer surface of side walls 14 and 16, and rear wall 19, of frypot 10, between them and outer walls 36. Referring specifically to FIG. 3, a side view of one convective heating zone 30 is shown, with the corresponding outer wall 36 removed. Convective heating zone 30 can have upper portion 32, lower portion 33, one or more fins 34, and a partition 35 disposed therein. All of convective heating zones 30 are in fluid communication with a blower 50 and plenum 55.

During operation of the fryer, as shown by the directional arrows in FIG. 3, ambient and/or conditioned air can be drawn in by blower 50, passed through plenum 55, through heating zones 24, and over burner 20. This air is then passed up through lower portion 33 of convective heating zone 30, where the flow can be disrupted by fins 34. The disruption by fins 34 of the flow of air in this manner helps to ensure that the air assists in the heating of, or in the transfer of heat away from, outer walls 14 and 16, as will be discussed in greater detail below.

The air is then directed toward a front of frypot 10 by partition 35, and passes through upper portion 32 toward a rear direction of frypot 10, where it passes out of frypot 10 through a flue (not shown) on rear wall 19. Fins 34 can be disposed in either lower portion 33, as shown, or upper portion 32, or both. In addition, while in the shown embodiment convective heating zone 30 has two portions 32 and 33, the present disclosure contemplates three or more portions of convective heating zone 30, that can be stacked on top of one another, and provide further heating of the oil within frypot 10. As will be discussed in greater detail below, this feature provides many advantages for the fryer of the present disclosure, including increasing the fryer efficiency, controlling the operating temperature (the “set point”) of the cooking oil when the fryer is in use, and enhancing the longevity of the cooking oil.

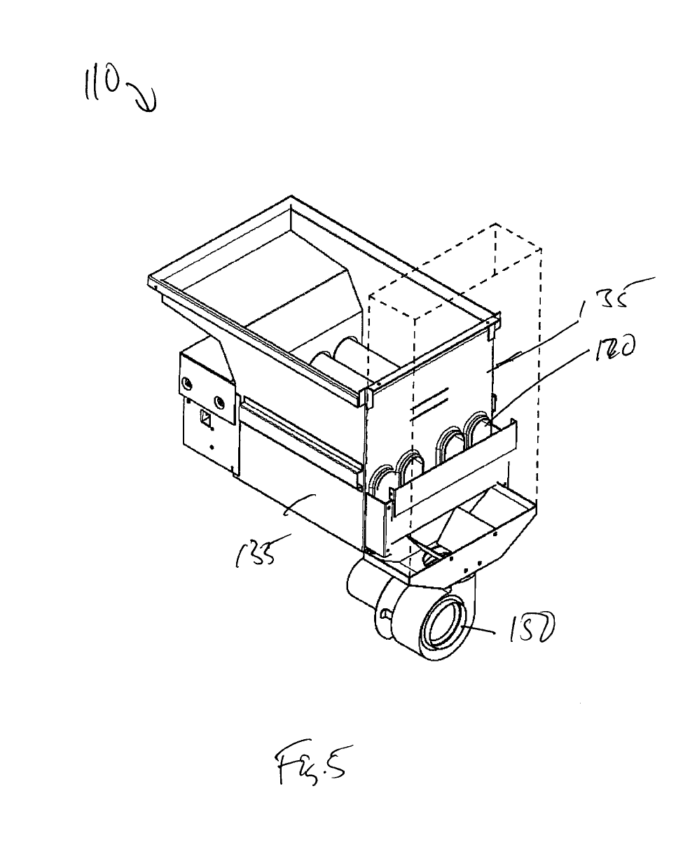

Referring to FIG. 4, an illustration of an exemplary fryer is shown, and generally represented by reference numeral 5. Fryer 5 has a housing 7, a pair of frypots 10, and a pair of filter pans 60, which can be used in conjunction with the filtration system discussed above and in the co-pending application having Attorney Docket No. 315.8883USU. Each of the pair of filter pans 60 contains a filter medium such as a filter pad 65, that is used to remove particles from the used cooking oil. Alternatively, both frypots 10 could share a common filter and return system.

While fryer 5 is shown as only having two frypots 10, there could be as many as twelve fryer pots, depending upon the needs of the food service professional, all with the same or different sizes. Fryer 5 also has a controller 80 for monitoring and maintaining overall operation the frypot 10, which in one embodiment can be within housing 7. Housing 7 also has a control display panel 90 that displays various measurements of deep fryer and accepts input for programming of controller 80. Controller 80 controls entire operation and cooking programs of various food products. As will be discussed in greater detail below, controller 80 can control blower 50 independently of burners 20. In currently available systems, this feature is not available, as blowers are commonly activated in conjunction with the burners. The present application is not limited to cooking oil, thus fat or shortening could also be used in the present application.

Frypot 10 can have temperature probes or sensors 82 therein that are in communication with controller 80, and which sense or detect temperature of oil in frypot 10. Controller 80 queries temperature sensor 82 and receives signals indicative to temperature of oil in fryer pot 10. Controller 80 is thus able to monitor the temperature of oil from measurements of sensor 82, and can also compute the rate of change of temperature of oil in response to heat supplied from burners 20.

During operation of fryer 5, there can be four main modes of operation, namely start-up mode, idle mode, cooking mode, and filtration mode. Generally speaking, start-up mode refers to the time when new or filtered cooking oil is placed in frypot 10, and heated from an ambient or relatively low temperature, to the desired temperature or set point for cooking, which the user can input into display panel 90. Idle mode refers to when there is no food product to be cooked in frypot 10, but it is desired to keep the oil at frypot at an elevated temperature, such as at the set point, so that it will not be necessary to heat the oil again when food product is cooked. Cooking mode is when there is food in frypot 10 that is being cooked. Filtration mode, as discussed above, is when a determination has been made that too much debris has collected in frypot 10, and that the oil has to be removed through drain 40 and the sediment removed from the frypot.

As part of the initiation of start-up mode, the user will input a set point temperature into display panel 90, which will be communicated to controller 80. Controller 80 will then activate burners 20 and, optionally, blower 50, to heat the oil within frypot 10. When blower 50 and burners 20 are on at the same time, the efficiency of the heating of the oil within frypot 10 is enhanced. As discussed above, air being drawn in by blower 50 is passed through heating zones 24, and then up through zones 30 on the sides and rear of frypot 10. As the air will be heated by passing over burners 20 in zones 24, it will then provide additional heating of frypot 10 along its sides and rear. Thus, convective heating zones 30 provide enhanced efficiency for frypot 10, since the oil disposed within frypot 10 is also heated along vertical sides of frypot 10, i.e. at side walls 14 and 16, and rear wall 19. This adds to the heating already being performed along angled portions 15 and 17, discussed above. Blower 50 can also supply air to burners 20, which can also help enhance the combustion of the burners.

During startup mode, blower 50 can also be used to help keep the temperature of the oil within frypot 10 within desired limits of the set point. This helps to prevent overshoot of the set point, which can lead to rapid degradation of the cooking oil, and also results in wasted gas used in burners 20. As discussed below, the present disclosure has provided a way of operating frypot 10 that eliminates or minimizes these disadvantages.

By way of illustration, and in one embodiment, the set point can be 340° F. Controller 80 will operate burners 20 and blower 50 so that the temperature of the cooking oil is brought within a first range of the set point, which in one embodiment can be approximately 20° F. Controller 80 can determine the temperature of the cooking oil by repeatedly monitoring temperature probe 82. When the cooking oil is within the first range of the set point, burners 20 are modulated by controller 80, in a sequential fashion as the rising temperature of the oil is monitored. Modulation is accomplished by supplying gas to burners 20 in a predetermined on and off sequence. For example, burners 60 are modulated in a range of from approximately 10° F. below a set point of 340° F.

By constantly receiving feedback from temperature probes 82, controller 80 monitors the rate of change of temperature of the cooking oil in response to the amount of gas being supplied to burners 20. Controller 80 is also able to extrapolate the temperature increase of the cooking oil, in response to the amount of gas that is being supplied to burners 20. If the extrapolated temperature exceeds the set point, controller 80 sends a signal to turn the burners off 20, and activate blower 50. This causes cooler, ambient air to blow through heating zones 24 and 30, and to blow heated air away from burners 20. Thus, in addition to enhancing heating when burners 20 are operating, blower 50 can help to transfer heat away from frypot 10 at side walls 14 and 16, rear wall 19, and angled portioned 15 and 17, by blowing relatively cool ambient air or conditioned air over those surfaces, when burners 20 are not activated. This minimizes the likelihood that oil temperature will overshoot the set point. The present disclosure has thus eliminated a significant disadvantage of currently available systems. Namely, the inability to stop the elevation of the oil temperature in response to the modulation of gas to burners, which causes cooking oil to overshoot the set point temperature.

Controller 80 can continuously monitor the actual and extrapolated temperature of the oil in frypot 10, and turn blower 50 or burners 20 on and off as needed. The same can be true when fryer 5 is operating in idle mode, i.e. when the fryer maintains the oil within frypot 10 at a desired temperature, even when there is no food product being cooked. Controller 80 can also monitor the temperature of the cooking oil during a cooking mode, and operate blower 50 and burners 20 to keep the temperature within a desired limit of the set point.

Additionally, blower 50 enhances heat transfer from side walls 14 and 16, and rear wall 19, during a filtration mode to minimize the likelihood of scorched oil on the inner surface of frypot 15. Controller 80 selectively controls the on and off cycles of blower 50 depending upon the cooking cycle.

Controller 80 periodically monitors predetermined settings relating to the product cooks or overall number of cooks in frypot 10, to determine the need for a filtration cycle to filter cooking oil. If controller 80 recognizes a need to filter cooking oil, controller 80 can determine whether burners 20 have been active within a first period of time of when the need for a filtration has been detected. If they have, controller 80 can turn off burners 20 (if they were not already off), and turn on blower 50 for a second period of time before initiating the filtration process, to send ambient or conditioned air around frypot 10. Filtration mode would begin after the second period of time is complete.

Cooling the walls of frypot 10 in this manner ensures that any oil remaining in frypot 10 after the oil is drained for filtration (such as any films of oil that may remain on the interior of frypot 10) is not scorched by an overheated frypot 10. Blower 50 is kept on during the remainder of the filtration cycle.

If burners 20 have not been on within the first period of time described above, then there is no need to wait the second period of time before initiating filtration mode. Controller 80 will turn on blower 50, and initiate filtration mode.

In one embodiment, the first period of time can be fifteen seconds or sixty seconds, and the second period of time can be forty-five or sixty seconds. Thus, when controller 80 receives a signal that filtration is needed, it determines whether burners 20 have been on within the last fifteen, or sixty seconds. If so, blower 50 is turned on for forty-five, or sixty seconds before filtration mode is initiated. If burners 20 have not been active within fifteen or sixty seconds of when the signal to begin filtration is received, controller 80 initiates filtration mode right away, and turns blower 50 on. The present disclosure contemplates any periods of time that are needed to cool frypot 10 to an acceptable level to prevent scorching.

Blower 50 thus sends relatively cool ambient and/or conditioned air around frypot 10 in the way described above. By enhancing heat transfer away from side walls 14 and 16, rear wall 19, angled portions 15 and 17, and burners 20, blower 50 helps to minimize scorching of the film oil that remains in frypot 10 after and during filtration.

Referring to FIG. 5, a second embodiment of a frypot of the present disclosure is shown, and represented by numeral 110. Frypot 110 can function in a similar manner as frypot 10, with the exception of the fact that frypot 110 uses combustion heat exchanger tubes 120, instead of infrared burners. Frypot 110 has blower 150 operably connected thereto. Blower 150 can circulate ambient and/or conditioned air thru the tubes 120 and/or sides 135 of frypot 110, in a similar fashion to how these tasks are performed in frypot 10. Blower 150 is shown as being below frypot 110, so that air is blown in an upward direction, but blower 150 can also be located at a front of frypot 110, so that air is blown toward frypot 110 in a horizontal direction.

FIGS. 1-3 show a single blower 50 associated with each frypot 10. However, one or more blowers could be used with each frypot 10. Additionally, blower 50 could used together with controller 80 and temperature probe 82 with a wide range of fryers, such as, for example, open pot fryers, tube fryers, or electrical fryers. Although blowers 50 and 150 are shown in conjunction with specific frypot designs, the present disclosure contemplates the use of a blower in conjunction with any frypot, to enhance heating and regulate temperature of a frypot by passing ambient and/or conditioned air around the frypot.

Often times, the fryer will be used in kitchen environments where airborne particle contaminants such as flour or other cooking condiments can be drawn into blower 50, or a screen (not shown) through which blower 50 draws air. The present disclosure provides a sensor (not shown) in communication with controller 80 that can be disposed adjacent to blower 50, or within plenum 55, to determine when the output of blower 50 is insufficient to support clean combustion over burners 20. The sensor can be a vane, or a pressure switch. In one embodiment, the sensor is a pressure switch located in plenum 55, which monitors blower pressure therein, in correlation to the intake of air by blower 50 through the screen. If the sensor determines that blower 50 is not providing enough output, then it can send a signal that will lock out any further cooking until blower 50 or the blower screen is cleaned. In one embodiment, it can take three consecutive fail signals, on three consecutive heat cycles, from the sensor before further cooking is prohibited. The sensor can also be configured so that if it trips during a cooking cycle, the rest of that cooking cycle will be allowed to be completed, before further cooking is shut down.

In addition, in one embodiment, an overall height of frypot 10 can be about eighteen inches, and frypot 10 can have a volume ranging from thirty, to seventy-five, to eighty-six, to one hundred five, to one hundred fifty pounds of cooking oil within interior volume 12, or any sub ranges in between. The materials of frypot 10 can be any that are suitable for contact with food and safe for cooking at high temperatures, such as but not limited to, stainless steel. In another embodiment, frypot 10 can be designed for open pot four- or six-head chicken frying, and where a controller (not shown) allows for individualized programming and cooking opportunities for multiple food products. A user can select a preset program from the control panel that contains cooking parameters for the type an amount of food that is to be cooked.

While the present disclosure discusses features in the singular case, it is understood that singular terms can also mean their plural equivalents where applicable. In addition, the present disclosure has been described with particular reference to certain embodiments. It should be understood that the foregoing descriptions and examples are only illustrative of the invention. Various alternatives and modifications thereof can be devised by those skilled in the art without departing from the spirit and scope of the present disclosure. Accordingly, the present disclosure is intended to embrace all such alternatives, modifications, and variations that fall within the scope of the appended claims.

What is claimed is:

1. A frypot for cooking food products, comprising:
a bottom surface;
a plurality of side walls, which form an interior volume for storing a cooking medium to cook the food products; and
a burner connected to said bottom surface for heating said cooking medium through said bottom surface,
wherein said bottom surface comprises two angled portions, and wherein said angled portions are angled so that there is no cold zone formed within said interior volume.

2. The frypot of claim 1, further comprising;
a bottom air passage between said burner and said bottom surface of said frypot; and
a blower in fluid communication with said bottom air passage, wherein said blower forces air through said bottom air passage.

3. The frypot of claim 2, further comprising at least one side air passage on an outer side of at least one of said side walls, wherein said side air passage is in fluid communication with said bottom air passage and said blower.

4. The frypot of claim 3, wherein said side air passage comprises an upper portion and a lower portion that are in fluid communication with each other, and separated with a divider, so that said blower forces air through said bottom air passage, into said lower portion of said side air passage, and into said upper portion of said side air passage.

5. The frypot of claim 4, wherein at least one of said lower portion and said upper portion have a plurality of fins disposed therein, to disrupt the flow of said air.

6. The frypot of claim 1, wherein said bottom surface further comprises a flat middle portion connected to each of said angled portions, wherein said angled portions form a v-shape with said flat middle portion.

7. A fryer for cooking food products, comprising:
a frypot;
a blower; and
at least one air passage within said frypot and in fluid communication with said blower, so that said blower passes air through said air passage.

8. The fryer of claim 7, wherein said air passage is located on at least one external side of said frypot.

9. The fryer of claim 7, further comprising at least one heat exchanger tube within said frypot, and
wherein said air passage is located within said heat exchanger tube.

10. The fryer of claim 7, further comprising at least one temperature sensor, wherein said temperature sensor is communication with an interior volume of said frypot, to detect a temperature therein.

11. The fryer of claim 10, further comprising:
at least one burner for heating a cooking medium within said frypot; and
a controller in communication with said temperature sensor, said burner, and said blower,
wherein said controller calculates a temperature of said frypot based on input from said temperature sensor, and selectively turns said blower and said burner on and off, based on said temperature of said frypot.

12. A method of operating a fryer for cooking food products, the fryer comprising a frypot and a cooking medium within said frypot, the method comprising the steps of:
controlling the fryer to enter a start up mode when said cooking medium is placed in said frypot, to raise a temperature of said cooking medium to a set point temperature;
controlling said fryer to enter a cooking mode when the food products are placed in the fryer; and
controlling said fryer to enter a filtration mode to filter and replace said cooking medium within said frypot.

13. The method of claim 12, further comprising the step of controlling said fryer to enter an idle mode, to keep said cooking medium at or near said set point temperature when no food products are being cooked by said fryer.

14. The method of claim 12, wherein the fryer further comprises:
at least one burner;
at least one blower;
at least one air passage on an exterior side of said frypot in fluid communication with said blower, so that said blower can pass air through said air passage; and
a controller,
wherein during said start up mode, said controller modulates said burner and said blower to raise said temperature of said cooking medium to said set point temperature.

15. The method of claim 14, wherein during said filtration mode, said controller turns said burner off and controls said blower to blow air though said air passage, to cool said frypot.
